(19) United States
(12) Patent Application Publication
(10) Pub. No.: US 2025/0166022 A1
(43) Pub. Date: May 22, 2025

(54) SPREADSHEET ADD-ON FOR eCOMMERCE

(71) Applicant: PACVUE CORPORATION, CULVER CITY, CA (US)

(72) Inventor: Zhaohui Tang, Bellevue, WA (US)

(21) Appl. No.: 19/032,907

(22) Filed: Jan. 21, 2025

Related U.S. Application Data
(63) Continuation of application No. 16/874,374, filed on May 14, 2020, now abandoned.
(60) Provisional application No. 62/847,581, filed on May 14, 2019.

(51) Int. Cl. G06Q 30/0241; G06F 8/61; G06F 9/445; G06F 16/27; G06F 40/18; G06Q 10/10; H04L 67/00

(52) U.S. Cl. CPC G06Q 30/0277; G06F 8/61; G06F 9/44526; G06F 16/27; G06F 40/18; G06Q 10/10; H04L 67/34

(57) ABSTRACT

A system includes an add-on object configured to be installed on a user's computing system, the computing system comprising at least one processor and a display, the at least one processor configured to run a spreadsheet application, the add-on object configured to be integrated with the spreadsheet application, the add-on object configured to communicate over a network with at least one eCommerce platform, the add-on object configured to enable the user to manage using the spreadsheet application an advertising campaign within the at least one eCommerce platform.

### PRIORITY CLAIM

This application is a continuation of U.S. patent application Ser. No. 16/874,374 filed May 14, 2020, which application claims priority to U.S. Provisional Patent Application No. 62/847,581 filed May 14, 2019, the contents of which are hereby incorporated by reference in their entirety as if fully set forth herein.

### BACKGROUND

An eCommerce report allows an entity to analyze purchase activity on its website or application. Such reports allow the entity to see product and transaction information, average order value, ecommerce conversion rate, time to purchase, and other data. A current process of generating an eCommerce report is to export relevant gathered data into an external spreadsheet application (e.g., the standard Excel tool), manage tasks or otherwise perform analysis within the spreadsheet and then manually transfer resultant information back into the eCommerce platform tool.

Such current process takes a user too much time in exporting, organizing, filtering, uploading the new data back to the eCommerce platform and performing many other management tasks.

### BRIEF DESCRIPTION OF THE DRAWING FIGURES

FIG. 1 schematically illustrates a system according to one or more embodiments of the invention; and

FIGS. 2A-6 show screenshots generated according to and illustrating one or more embodiments of the invention.

### DETAILED DESCRIPTION

This patent application is intended to describe one or more embodiments of the present invention. It is to be understood that the use of absolute terms, such as “must,” “will,” and the like, as well as specific quantities, is to be construed as being applicable to one or more of such embodiments, but not necessarily to all such embodiments. As such, embodiments of the invention may omit, or include a modification of, one or more features or functionalities described in the context of such absolute terms.

Embodiments of the present invention may comprise or utilize a special-purpose or general-purpose computer including computer hardware, such as, for example, one or more processors and system memory, as discussed in greater detail below. Embodiments within the scope of the present invention also include physical and other computer-readable media for carrying or storing computer-executable instructions or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special-purpose computer system. Computer-readable media that store computer-executable instructions are non-transitory computer-readable storage media (devices). Computer-readable media that carry computer-executable instructions are transmission media. Thus, by way of example, and not limitation, embodiments of the invention can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special-purpose computer.

A “network” is defined as one or more data links that enable the transport of electronic data between computer systems or modules or other electronic devices. When information is transferred or provided over a network or another communications connection (either hardwired, wireless, or a combination of hardwired or wireless) to a computer, the computer properly views the connection as a transmission medium. Transmissions media can include a network or data links which can be used to carry desired program code means in the form of computer-executable instructions or data structures and which can be accessed by a general purpose or special-purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special-purpose computer, or special-purpose processing device to perform a certain function or group of functions. In some embodiments, computer-executable instructions are executed on a general-purpose computer to turn the general-purpose computer into a special-purpose computer implementing elements of the invention. The computer executable instructions may be, for example, binaries, intermediate format instructions such as assembly language, or even source code.

According to one or more embodiments, the combination of software or computer-executable instructions with a computer-readable medium results in the creation of a machine or apparatus. Similarly, the execution of software or computer-executable instructions by a processing device results in the creation of a machine or apparatus, which may be distinguishable from the processing device, itself, according to an embodiment.

Correspondingly, it is to be understood that a computer-readable medium is transformed by storing software or computer-executable instructions thereon. Likewise, a processing device is transformed in the course of executing software or computer-executable instructions. Additionally, it is to be understood that a first set of data input to a processing device during, or otherwise in association with, the execution of software or computer-executable instructions by the processing device is transformed into a second set of data as a consequence of such execution. This second data set may subsequently be stored, displayed, or otherwise communicated. Such transformation, alluded to in each of the above examples, may be a consequence of, or otherwise involve, the physical alteration of portions of a computer-readable medium. Such transformation, alluded to in each of the above examples, may also be a consequence of, or otherwise involve, the physical alteration of, for example, the states of registers and/or counters associated with a processing device during execution of software or computer-executable instructions by the processing device.

As used herein, a process that is performed “automatically” may mean that the process is performed as a result of machine-executed instructions and does not, other than the establishment of user preferences, require manual effort.

An embodiment includes an add-on or plug-in application, which directly converts any data generated by an eCommerce platform to a spreadsheet. An embodiment converts the data on the platform into a spreadsheet view and makes the viewing more user-friendly. An embodiment can directly work as a spreadsheet add-on and synchronize the spreadsheet data with the eCommerce platform at the same time that the spreadsheet is being edited.

An embodiment includes a spreadsheet plug-in, which means the user does not need to export any data from the platform. The user can directly have the organized spreadsheet view when the user logs in to his/her eCommerce account in any web browser.

An embodiment allows the user to edit the data or manage the task as using a spreadsheet and write back the information to its original platform. This spares the user the requirement of downloading/uploading between the eCommerce platform and the spreadsheet. In the platform, managing a task may require a user to work on different pages, but with the spreadsheet add-in according to an embodiment, all data/information can appear on one page.

An embodiment allows the user to login to what may be referred to herein as “Pacvue,” a proprietary SaaS, as well as eCommerce platforms, execute eCommerce related tasks such as product listing, advertising, and business intelligence reporting inside the spreadsheet software itself with real-time synchronization between the spreadsheet edits and eCommerce platform.

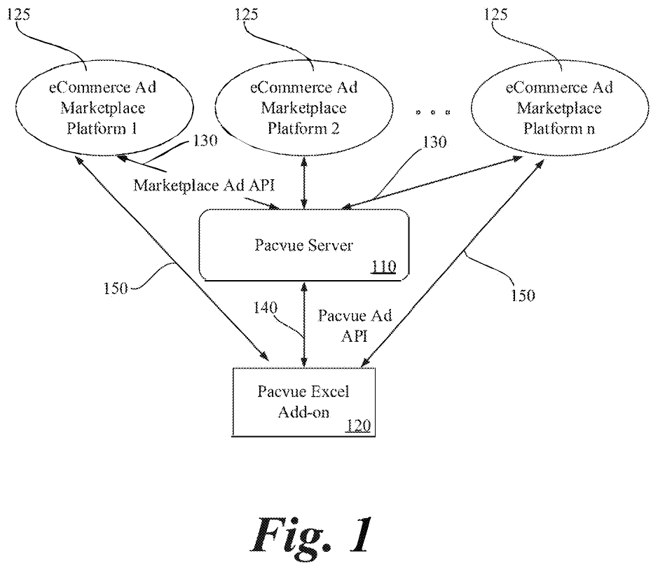

As illustrated in FIG. 1, one or more embodiments of the invention may include two components: Pacvue Server 110 and Pacvue Spreadsheet Add-on 120. Pacvue Server 110 communicates with eCommerce platforms 1, 2, n 125 (associated with, for example, Amazon, Walmart, Target, etc.) via marketplace ad application program interfaces (APIs) 130 provided by those respective eCommerce Platforms. Pacvue Spreadsheet Add-on 120 can be a plug-in inside the spreadsheet application (e.g., Excel). In an embodiment, the Add-on 120 is developed using the spreadsheet framework. Add-on 120 communicates with Server 110 via a Pacvue Ad API 140. Add-on 120 may also communicate directly with eCommerce platforms 1, 2, n 125 using marketplace ad APIs 150, which may or may not function the same as APIs 130, provided by those respective eCommerce Platforms.

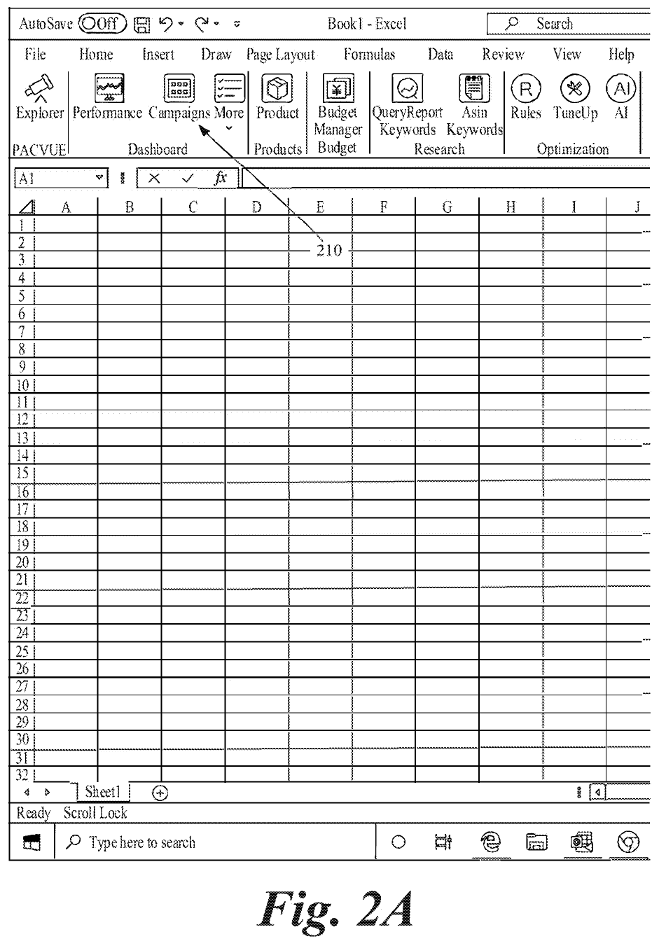

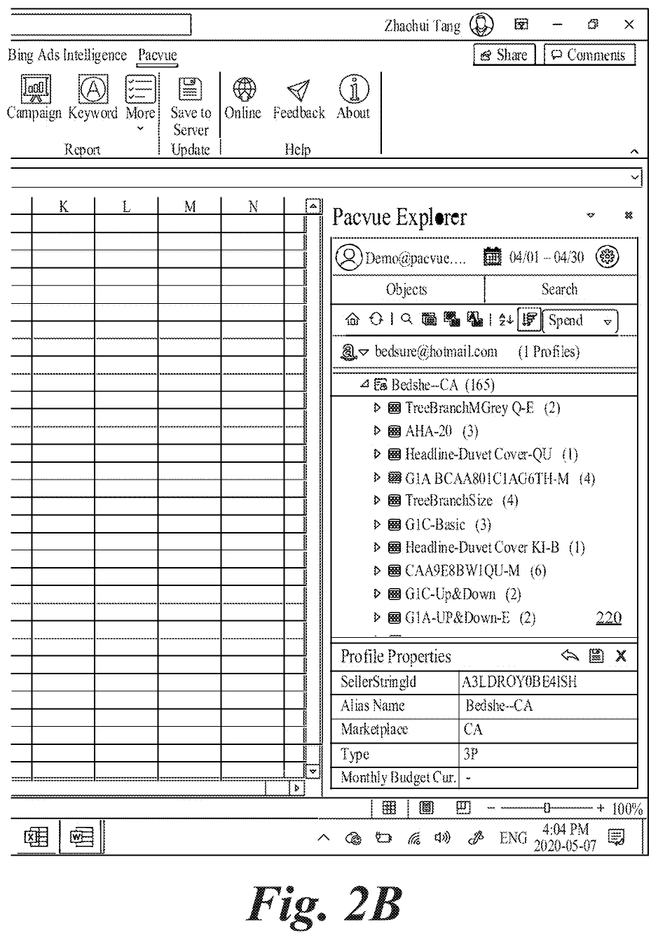

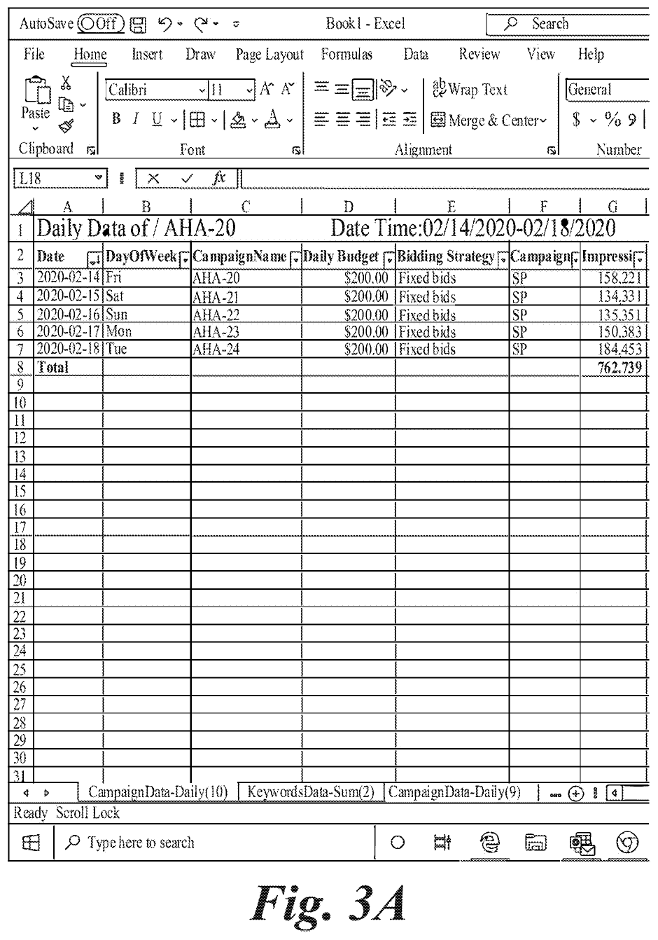

Pacvue Spreadsheet Add-on 120 allows users to retrieve data from Pacvue server 110 and eCommerce platforms 1, 2, n 125 via the above-discussed APIs 130, 140, 150. Pacvue server 110 may be an eCommerce platform tool that enables the user to manage their advertising behavior on eCommerce platforms 125. Pacvue Server 110 provides the functions shown in the ribbon at the top of FIGS. 2A-2B. Pacvue Server 110 receives the API data from the eCommerce platforms 125 and performs some management or calculations at the back end. The Add-on 120 receives the data both from the eCommerce platforms 125 and the additional data that Pacvue Server 110 provides. Pacvue Server 110 also provides login functions and serves to provide the Add-on 120 object to a user's computer to allow integration with the spreadsheet.

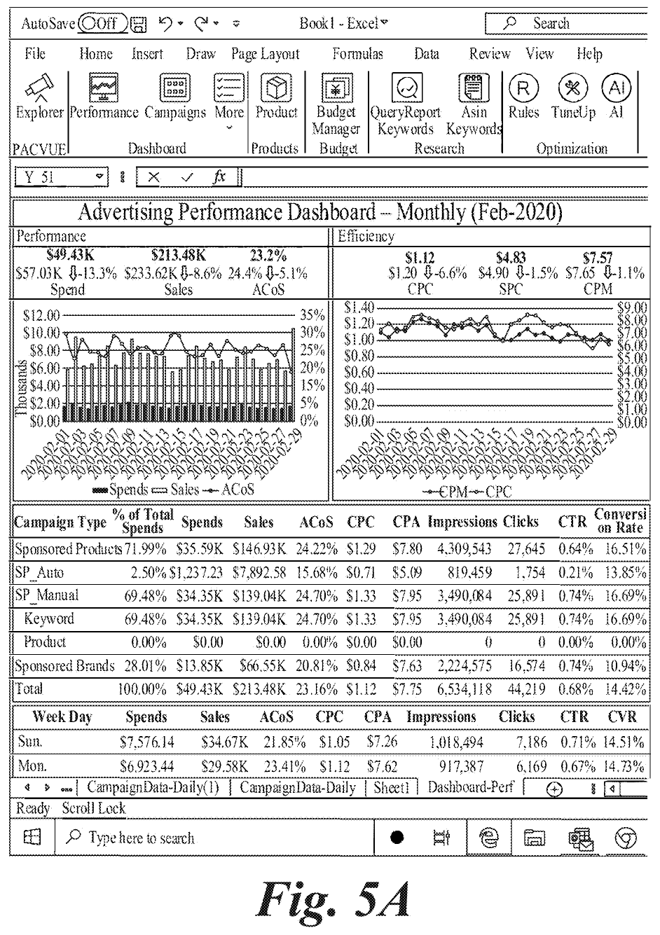

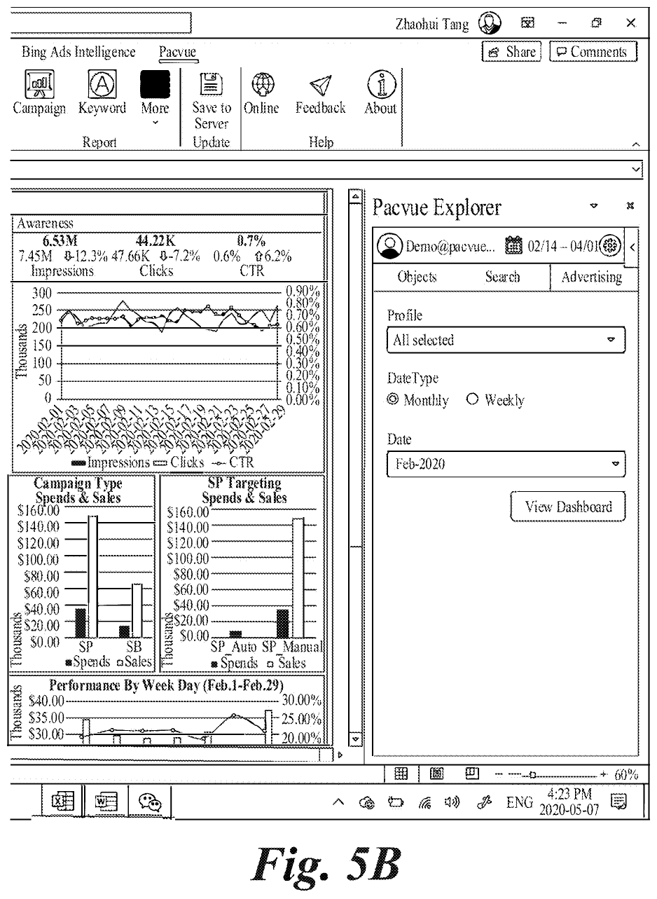

Add-on 120 also allows users to write back data to eCommerce platforms 1, 2, n 125. As illustrated in FIGS. 5A-5B, Spreadsheet Add-on 120 leverages business intelligence features such as charting, data table and pivot table built from the spreadsheet, while allowing the user to manage eCommerce tasks such as Amazon advertising and Amazon product listing directly inside Spreadsheet. For example, the user can look at the advertising campaign reports on Amazon from Spreadsheet Add-on 120. User can add/remove keywords to/from an Amazon search campaign inside Spreadsheet. These updates can be sent back to Pacvue server 110 and Amazon server via APIs 130.

Referring to FIGS. 2A-2B, a top section ribbon 210 shows the functions of the Pacvue server 110 that includes the Dashboards section, which shows the ads performance data. The Products section shows the sales and inventory data. The Research section shows keyword suggestion and keyword analyzation. The Report section shows general reports and customer reports. The Competitor analyzation section can audit the user's brand with its competitors. The Event calendar saves a customized calendar and saves historical data of the changing of key performance indicators (KPIs), like big, budget, etc. The right-side panel 220 shows available accounts that the user can examine. In the example of FIG. 2B, the user account is an Amazon vendor account of Bedsure, which include eight profiles.

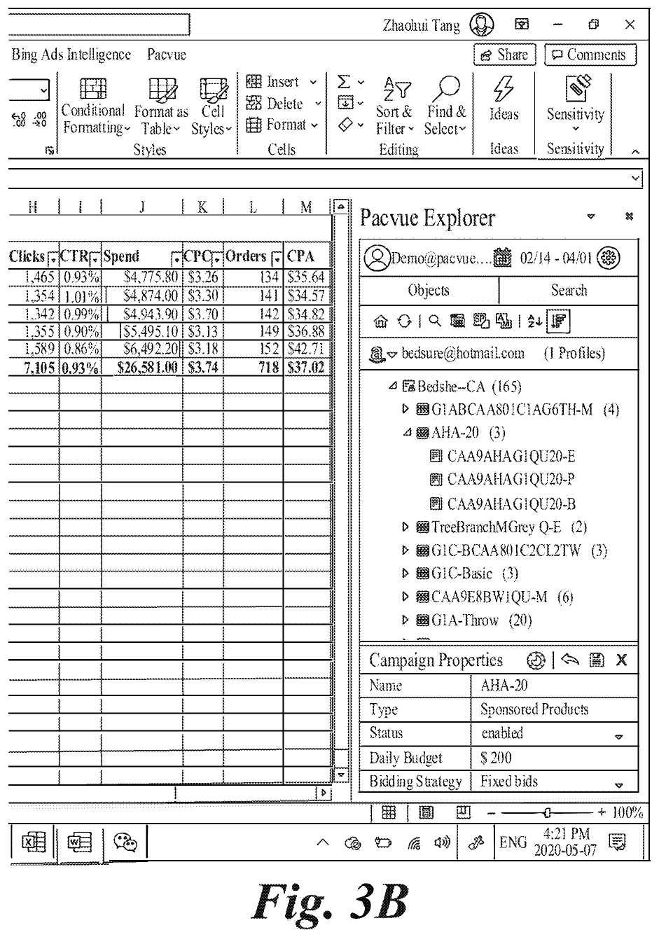

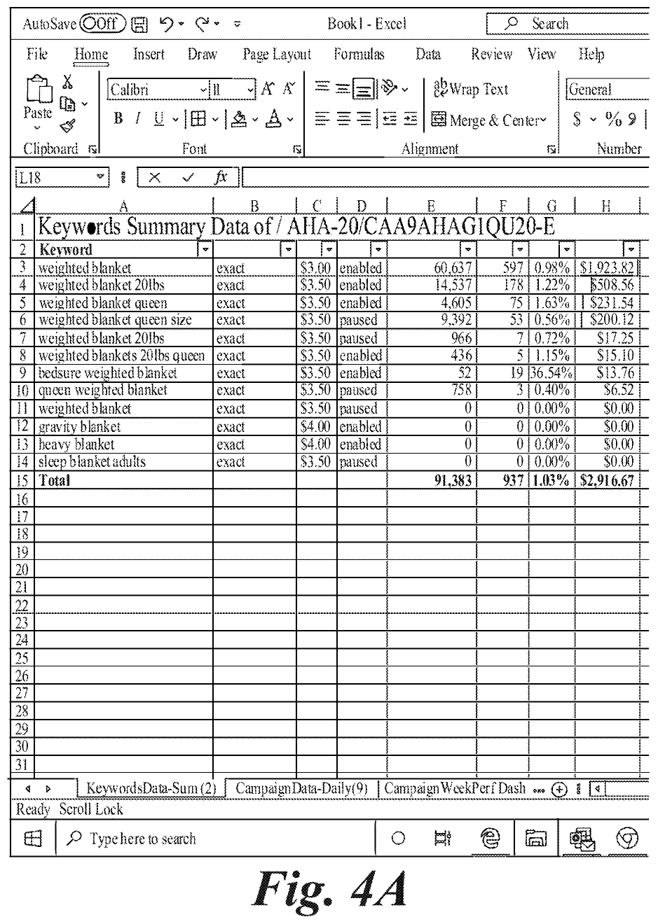

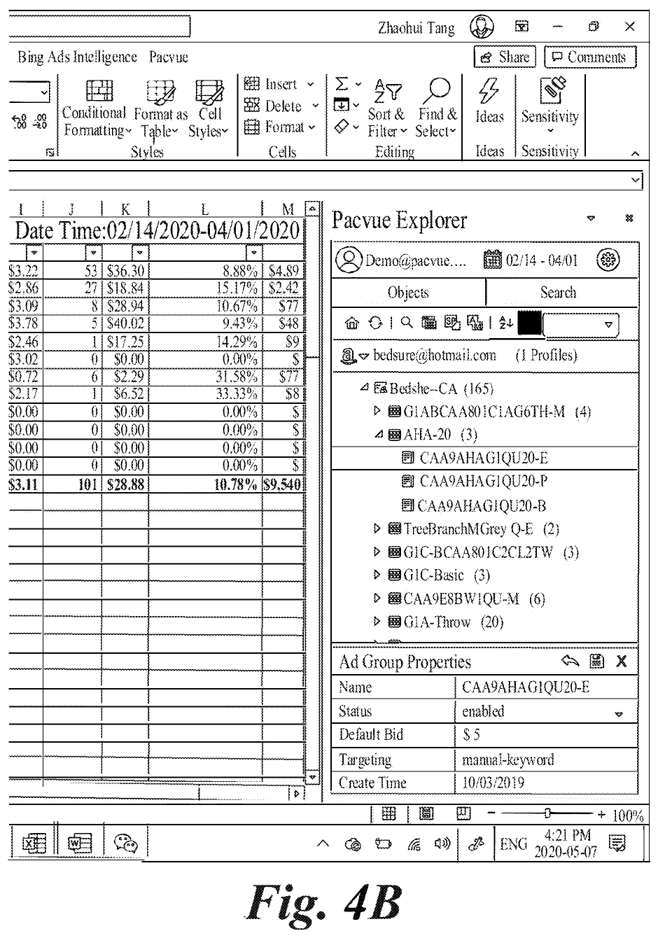

FIGS. 3A-4B respectively illustrate expansion of a profile, showing the data characterizing a campaign and an expansion of a campaign, showing the data of an Adgroup.

FIGS. 5A-5B illustrate a performance-data dashboard, showing the data in a time interval, which can be customized, and a graph of the trend with the selected profiles.

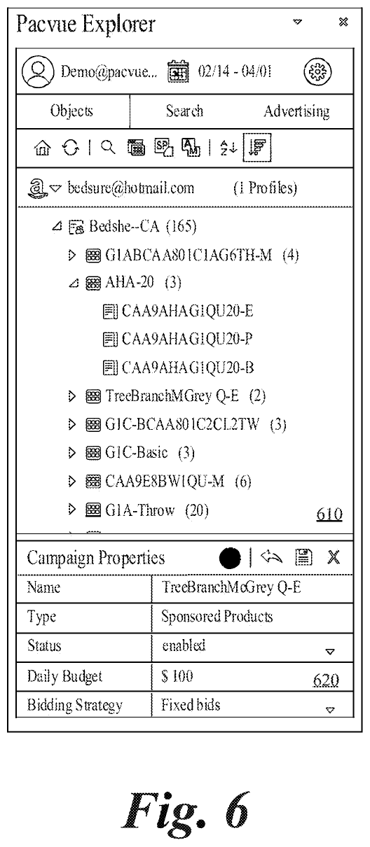

Referring to FIG. 6, an embodiment provides an Object Explorer 610 inside spreadsheet software, similar to right-side panel 220 shown in FIG. 2B, that displays the objects of an eCommerce platform. These objects could be product profiles, Campaign, AdGroup, Keywords, etc. The system displays the attributes and meta data of these objects that physically reside at the eCommerce platform 125. The user can also manage these objects (add, delete, update, etc.). These user operations will write back to the eCommerce platform 125 directly or indirectly via Pacvue Server 110. The bottom portion 620 illustrates the current ad-campaign settings and level properties for a particular product.

The system allows a user to login to Pacvue Server 110 as well as eCommerce platforms 1, 2, n, 125 and execute eCommerce related tasks such as product listing, advertising, business intelligence reporting inside the spreadsheet software itself.

While the preferred embodiment of the disclosure has been illustrated and described, as noted above, many changes can be made without departing from the spirit and scope of the disclosure. Accordingly, the scope of the described systems and techniques is not limited by the disclosure of the preferred embodiment. Instead, the described systems and techniques should be determined entirely by reference to the claims.

What is claimed is:

1. A system, comprising:
an add-on object configured to be installed on a user's computing system, the computing system comprising at least one processor and a display, the at least one processor configured to run a spreadsheet application, the add-on object configured to be integrated with the spreadsheet application, the add-on object configured to communicate over a network with at least one eCommerce platform, the add-on object configured to enable the user to manage using the spreadsheet application an advertising campaign within the at least one eCommerce platform.

2. The system of claim 1, further comprising a server intermediate and in signal communication with the add-on object and at least one eCommerce platform.

3. The system of claim 2 wherein the server is configured to provide the add-on object to the user's computing system to enable integration of the add-on object with the spreadsheet application.

4. The system of claim 1, wherein the add-on object is configured to enable data in the spreadsheet to be synchronized with the at least one eCommerce platform at the same time that the user is editing the data.

5. The system of claim 1, wherein the add-on object is configured to enable the user to alter parameters of an advertising campaign presented on the at least one eCommerce platform.

6. At least one computer-readable medium on which are stored instructions that, when executed by one or more processing devices, enable the one or more processing devices to perform a method, the method comprising the steps of:
installing an add-on object on a user's computing system, the computing system comprising at least one processor and a display, the at least one processor configured to run a spreadsheet application, the add-on object configured to be integrated with the spreadsheet application, the add-on object configured to communicate over a network with at least one eCommerce platform, the add-on object configured to enable the user to manage using the spreadsheet application an advertising campaign within the at least one eCommerce platform.

7. The at least one computer-readable medium of claim 6, wherein the one or more processing devices are intermediate and in signal communication with the add-on object and at least one eCommerce platform.

8. The at least one computer-readable medium of claim 7 wherein the one or more processing devices are configured to communicate with the at least one eCommerce platform via marketplace ad application program interfaces provided by respective ones of the at least one eCommerce Platform.

9. The at least one computer-readable medium of claim 6, wherein the add-on object is configured to enable data in the spreadsheet to be synchronized with the at least one eCommerce platform at the same time that the user is editing the data.

10. The at least one computer-readable medium of claim 6, wherein the add-on object is configured to enable the user to alter parameters of an advertising campaign presented on the at least one eCommerce platform.
